(19) United States
(12) Patent Application Publication
(10) Pub. No.: US 2017/0341020 A1
(43) Pub. Date: Nov. 30, 2017

(54) Hybrid Thermal Oxidizer Systems and Methods

(71) Applicant: Bechtel Hydrocarbon Technology Solutions, Inc., Houston, TX (US)

(72) Inventors: Rimon Vallavanatt, Missouri City, TX (US); Mahesh Subramanya, Houston, TX (US)

(73) Assignee: Bechtel Hydrocarbon Technology Solutions, Inc., Houston, TX (US)

(21) Appl. No.: 15/664,803

(22) Filed: Jul. 31, 2017

Related U.S. Application Data
(62) Division of application No. 13/790,781, filed on Mar. 8, 2013, now abandoned.

(51) Int. Cl. B01D 53/72

(52) U.S. Cl. CPC B01D 53/72; B01D 2257/7027

(57) ABSTRACT

Hybrid thermal oxidizer systems and methods for combusting waste gas and heating utility oil using an efficient transfer of heat from fuel gas. The hybrid thermal oxidizer includes a combustion chamber, a gas preheater and a quench chamber positioned between the combustion chamber and the gas preheater. The combustion chamber burns impurities in the waste gas to produce an exhaust gas. The gas preheater preheats the waste gas before burning impurities in the combustion chamber. And, the quench chamber controls a temperature of the exhaust gas before preheating the waste gas.

### CROSS-REFERENCE TO RELATED APPLICATIONS

The present application is a Divisional Application of and claims priority to U.S. application Ser. No. 13/790,781, titled “Hybrid Thermal Oxidizer Systems And Methods”, filed on Mar. 8, 2013, which is incorporated herein by reference in its entirety.

### STATEMENT REGARDING FEDERALLY SPONSORED RESEARCH

Not applicable.

### FIELD OF THE INVENTION

The present invention generally relates to hybrid thermal oxidizer systems and methods. More particularly, the invention relates to a hybrid thermal oxidizer for combusting waste gas and heating utility oil using an efficient transfer of heat from fuel gas.

### BACKGROUND OF THE INVENTION

In facilities that process liquefied natural gas (“LNG”), the natural gas is typically cleaned of impurities and cooled thus, removing a fair amount of energy to bring it to a liquid state. In this state, it is easy to transport in large quantities. Before bringing the gas to a liquid state, the impurities are removed from the raw gas. These impurities are burned in a conventional thermal oxidizer to break them down to CO₂, H₂O and nitrogen, for example. Based on the impurities, the thermal oxidizer needs to operate at elevated temperatures to minimize emissions. When a thermal oxidizer operates at a high temperature, the fuel gas leaves the unit at very high temperatures thus, wasting heat.

Referring now to FIG. 1, a conventional thermal oxidizer 100 is illustrated for use in an LNG facility. A fuel gas stream 101 enters a burner 102 at the same time a combustion air stream 104 enters the burner 102. The burner 102 combusts the fuel gas stream 101 and the combustion air stream 104 in a combustion chamber 106. Impurities from a waste gas 107 enter the combustion chamber 106 through inlet opening 108 at about 122° F. and are burned with the fuel gas stream 101 and the combustion air stream 104 to break them down into an exhaust gas comprising CO2, H2O and nitrogen, for example. Based on the type of impurities in the waste gas 107, the combustion chamber 106 needs to operate at an elevated temperature to minimize emissions in the exhaust gas. Emission requirements often require operating a conventional thermal oxidizer at much higher temperatures to obtain a 99.99% Destruction and Removal Efficiency (“DRE”). DRE is defined as the percentage of molecules of a compound removed or destroyed in the thermal oxidizer related to the number of molecules that entered the system. The operating temperature of a thermal oxidizer therefore, varies depending upon the impurities in the waste gas. If, for example, benzene, toluene, ethyl-benzene and xylenes (collectively referred to as “BTEX”) are present, then the combustion chamber 106 needs to operate at about 1742° F. with a residence time of 1.5 to 2 seconds for 99.99% DRE. Residence time is defined as the time of exposure of waste gas in the combustion chamber 106. The combustion air stream 104 entering the burner 102 may be regulated with a valve 112 so that if the temperature in the combustion chamber 106 drops below or goes above a predetermined value such as, for example, about 1742° F. when detected by a temperature sensor 110, the flow of combustion air stream 104 into the burner 102 may be increased or decreased using the valve 112. Likewise the fuel gas stream 101 entering the burner 102 may be regulated with a valve 103 so that if the temperature in the combustion chamber 106 drops below or goes above a predetermined value such as, for example, about 1742° F. when detected by the temperature sensor 110, the flow of fuel gas stream 101 into the burner 102 may be increased or decreased using the valve 103. In order to maintain the combustion air stream 104 ahead of the fuel gas stream 101 for safety reasons, the combustion air stream 104 entering the burner 102 may be regulated with the valve 112 so that if the oxygen in the combustion chamber 106 drops below a predetermined value such as, for example, about 2% when detected by an oxygen sensor 111, the flow of the combustion air stream 104 into the burner 102 may be increased using the valve 112. The exhaust gas from the combustion chamber 106 with impurities enters the fuel gas duct 113 before entering the exhaust stack 114 and exiting the top of exhaust stack 114 through an opening 116 into the atmosphere at about 1742° F. The exhaust gas exiting the conventional thermal oxidizer illustrated in FIG. 1 therefore, wastes a significant amount of heat.

Referring now to FIG. 2, a conventional fired heater 200 is illustrated for use in an LNG facility. Utility oil is used in the LNG facility to heat the feed gas, to heat gas turbine fuel and to remove carbon dioxide from the feed gas. The utility oil must be separately heated in a hot oil heater also referred to as a fired heater. A combustion air stream 202 and a fuel gas stream 204 enter a burner 206 at the same time. As a result, the combustion air stream 202 and the fuel gas stream 204 are heated by the burner 206 in a radiant section 208. The radiant section 208 includes vertical coiled tubing 210. A convection section 212 includes horizontal tubing (not shown). A utility oil stream 214 may be heated by directing the utility oil stream 214 through an inlet opening 216, through the horizontal tubing, through the vertical coiled tubing 210 and out an outlet opening 218 as a preheated utility oil stream 220. The utility oil is thus, heated from about 260° F. to about 475° F. as heat from the combustion of the combustion air stream 202 and the fuel gas stream 204 in the radiant section 208 and in the convection section 212 passes around the vertical coiled tubing 210 and the horizontal tubing as it rises through the fired heater 200 and exits through an exhaust stack 216 into the atmosphere at about 400° F.

Both a conventional thermal oxidizer and fired heater are significant pollutant emitting equipment in any LNG facility. With EPA regulations becoming more stringent, end users, EPA companies and heater/burner vendors face a constant challenge to improve processes and equipment design to reduce pollutant emissions.

### SUMMARY OF THE INVENTION

The present invention therefore, meets the above needs and overcomes one or more deficiencies in the prior art by providing systems and methods for combusting waste gas and heating utility oil using an efficient transfer of heat from fuel gas in a hybrid thermal oxidizer.

In one embodiment, the present invention includes a method for processing a hazardous waste gas, which comprises: i) burning impurities in the waste gas to produce exhaust gas; ii) controlling a temperature of the exhaust gas before preheating the waste gas; and iii) preheating the waste gas before burning the impurities using heat transferred from the exhaust gas preheater.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings, in which like elements are referenced with like numerals, wherein:

FIG. 1 illustrates a conventional thermal oxidizer used in an LNG facility.

FIG. 2 illustrates a conventional fired heater used in an LNG facility.

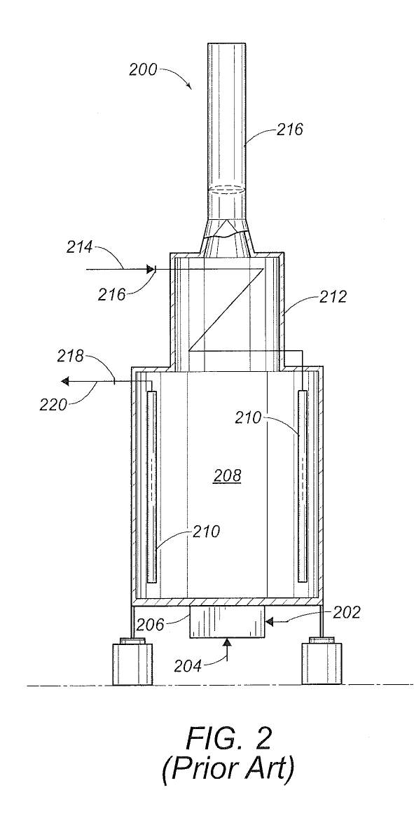

FIG. 3 illustrates one embodiment of a hybrid thermal oxidizer for use in an LNG facility.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may be applied in other industries to achieve similar results.

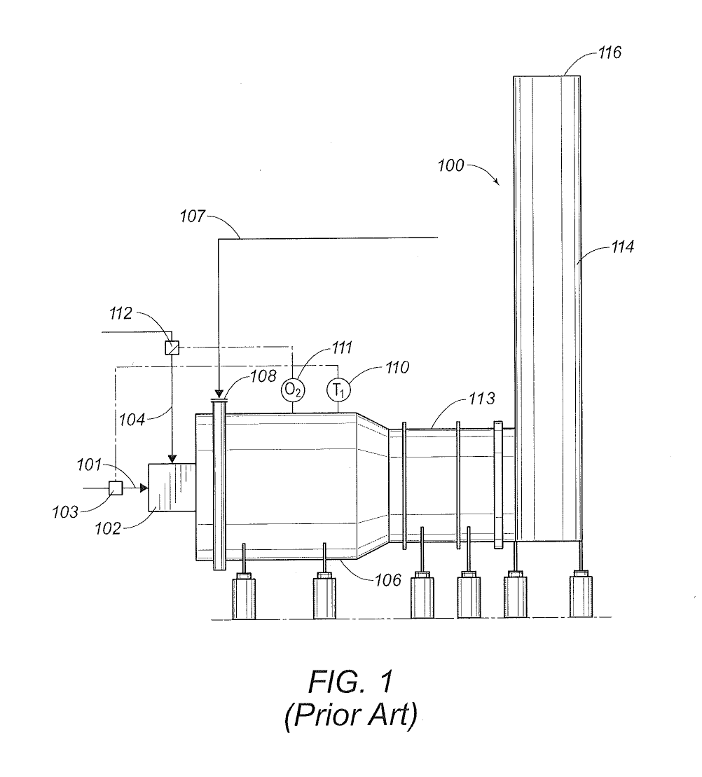

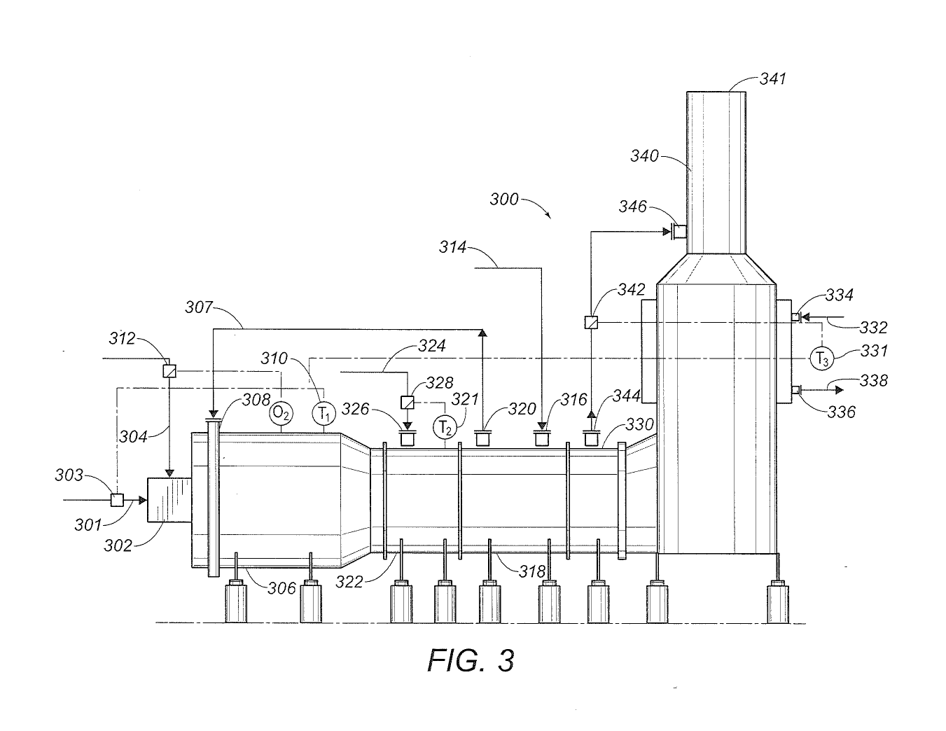

Referring now to FIG. 3, one embodiment of a hybrid thermal oxidizer is illustrated for use in an LNG facility. A fuel gas stream 301 enters the burner 302 at the same time a combustion air stream 304 enters the burner 302. The burner 302 combusts the fuel gas stream 301 and the combustion air stream 304 in a combustion chamber 306. Impurities from a preheated waste gas stream 307 enter the combustion chamber 306 through inlet opening 308 and are burned with the combustion air stream 304 and the fuel gas stream 301 at about 1742° F. to break them down into an exhaust gas in the same manner as described in reference to FIG. 1. The preheated waste gas stream 307, however, enters the combustion chamber 306 at a much higher temperature of about 900° F. than the waste gas stream entering a conventional thermal oxidizer. In this manner, less fuel gas stream 301 is required to burn and break down the impurities in the preheated waste gas stream 307 through combustion. The combustion air stream 304 entering the burner 302 may be regulated with a valve 312 so that if the temperature in the combustion chamber 306 drops below or goes above a predetermined value such as, for example, about 1742° F. when detected by a temperature sensor 310, the flow of combustion air stream 304 into the burner 302 may be increased or decreased using the valve 312. Likewise, the fuel gas stream 301 entering the burner 302 may be regulated with a valve 303 so that if the temperature in the combustion chamber 306 drops below or goes above a predetermined value such as, for example, about 1742° F. when detected by the temperature sensor 310, the flow of fuel gas stream 301 into the burner 302 may be increased or decreased using the valve 303. In order to maintain the combustion air stream 304 ahead of the fuel gas stream 301 for safety reasons, the combustion air stream 304 entering the burner 302 may be regulated with the valve 312 so that if the oxygen in the combustion chamber 306 drops below a predetermined value such as, for example, about 2% when detected by an oxygen sensor 311, the flow of the combustion air stream 304 into the burner 302 may be increased using the value 312.

A waste gas stream 314 enters a gas preheater 318 through inlet opening 316 where it passes through a coiled tubing and exits the gas preheater 318 through outlet opening 320 as the preheated waste gas stream 307 at about 900° F. The waste gas stream 314 may enter the gas preheater 318 at a temperature of about 122° F. The waste gas stream 314 should not be heated above a predetermined auto ignition temperature of the hydrocarbons in the waste gas stream 314 when the hydrocarbons in the waste gas stream 314 are more than 50% of a lower explosion limit. A lower explosion limit is the concentration of a gas or vapor in air capable of producing a flash fire in the presence of an ignition source.

A quench chamber 322 is positioned between the combustion chamber 306 and the gas preheater 318 to control the temperature of the exhaust gas exiting the combustion chamber 306 before it enters the gas preheater 318. A quench air stream 324 enters the quench chamber 322 through inlet opening 326, which is controlled and regulated by a quench air valve 328 and a temperature sensor 321 to maintain a predetermined temperature in the quench chamber 322 of about 1400° F. In this manner, the temperature of the exhaust gas from the combustion chamber 306 can be controlled to about 1400° F. before passing through to the gas preheater 318. Controlling the temperature of the exhaust gas before it enters the gas preheater 318 is necessary in order to avoid damaging the gas preheater 318. If, for example, the waste gas stream 314 entering the gas preheater 318 is interrupted for a while due to unexpected reasons, then the exhaust gas from the combustion chamber 306 may be controlled to a temperature of about 1400° F. in the quench chamber 322 before it passes through the gas preheater 318 at about the same temperature without damaging the coiled tubing therein. Otherwise, the exhaust gas exiting the combustion chamber 306 at about 1742° F. would directly enter the gas preheater 318 at about the same temperature and most likely damage the coiled tubing therein because the gas preheater 318 cannot handle such an elevated temperature due to high thermal expansion stresses. If, however, the waste gas stream 314 entering the gas preheater 318 is consistently uninterrupted at about 74,132 lbs/hr, then exhaust gas exiting the combustion chamber 306 at about 1742° F. is cooled in the quench chamber 322 to about 1400° F. and loses some of its heat in the gas preheater 318, to the waste gas stream 314 passing therethrough. The exhaust gas exits the gas preheater 318 at about 1097° F.

The exhaust gas exiting the gas preheater 318 enters a waste heat recovery module 330. A utility oil stream 332 enters an upper portion of the waste heat recovery module 330 through inlet opening 334, passes through a coiled tubing therein and exits the waste heat recovery module 330 through outlet opening 336. The utility oil stream 332 is used in a separate process for the LNG facility and, in this manner, is heated to about 475° F. using heat from the exhaust gas exiting the gas preheater 318 at about 1097° F. The heat from the exhaust gas in the waste heat recovery module 330 therefore, passes around the coiled tubing containing the utility oil stream 332, which exits outlet opening 336 as a preheated utility oil stream 338.

Heat from the exhaust gas passing through the hybrid thermal oxidizer 300 is therefore, used to efficiently produce a preheated waste gas stream 307 and a preheated utility oil stream 338. The exhaust gas exits exhaust stack 340 through an opening 341 into the atmosphere at about 424° F. or less. In order to control the temperature in the waste heat recovery module 330, a valve 342 and a temperature sensor 331 are used to regulate exhaust gas through outlet opening 344 thus, bypassing the waste heat recovery module 330 and entering exhaust stack 340 through inlet opening 346 at a temperature of about 1097° F. Regulation of the valve 342 therefore, controls the temperature of the preheated utility oil stream 338 to about 475° F. The temperature in the waste heat recovery module 330 may also be indirectly regulated by valve 303. If, for example, the utility oil temperature falls below about 475° F., even after full closure of valve 342, the fuel gas stream 301 may be increased through the valve 303 to increase the utility oil temperature to about 475° F.

### EXAMPLE

In the example below, table 1 summarizes the cost of using a regular Thermal Oxidizer (Regular TOₓ) and a fired heater. Table 2 summarizes the savings associated with using a Hybrid Thermal Oxidizer (Hybrid TOₓ) according to the present invention.

TABLE 1

| | | | (Regular TOₓ+ |
|---|---|---|---|
| | Regular TOₓ | Fired Heater | Fired Heater) |
| Equipment | $1,340,000 | $985,000 | $2,325,000 |
| Cost (+fuel skid) ($) | | | |
| Fuel Cost ($/yr) | $1,401,600 | $1,236,900 | $2,638,500 |
| NOₓ Emissions | 25.580 | 10.820 | 36.400 |
| (lbs/MM Btu/yr) | | | |

TABLE 2

| | Regular TOₓ+ | | |
|---|---|---|---|
| | (Fired Heater) | Hybrid TOₓ | Savings |
| Equipment | $2,325,000 | $2,200,000 | $125,000 |
| Cost (+fuel skid) ($) | | | |
| Fuel Cost ($/yr) | $2,638,500 | $1,401,600 | $1,236,900 |
| NOₓ Emissions | 36.400 | 25.580 | 10.820 |
| (lbs/MM Btu/yr) | | | |

In table 1, the fired heater fuel cost assumptions are 85% thermal efficiency for a 30 MM Btu/hr heater with a fuel usage of about 35.3 MM Btu/hr. The fuel cost is estimated at $4/MM Btu (no inflation/fluctuation considered), which results in about $1,236,900 per year. The Regular TOₓ fuel cost assumptions include a 40 MM Btu/hr Thermal Oxidizer with a fuel usage of about 40 MM Btu/hr. The fuel cost is estimated at $4/MM Btu (no inflation/fluctuation considered), which results in about $1,401,600 per year.

In table 2, the Hybrid TOx fuel cost assumes that no additional fuel consumption is required to heat the hot oil when the Hybrid TOₓ is operating under normal conditions to burn a waste gas stream.

In addition to the fuel cost savings, the Hybrid TOₓ also produces fewer noxious emissions (“NOₓ Emissions”). In table 1, the NOₓ Emissions for a conventional fired heater assume:

NOₓ emitted by a 30 MM Btu/hr heater, lbs/MM Btu/hr 0.035
Efficiency of the heater=85%
NOₓ emissions eliminated, lbs/MM Btu/yr=0.035*35.29*8,760=10,820
In table 1, the NOx Emissions for a Regular TOₓ assume:
NOₓ emitted by a 40 MM Btu/hr TOₓ, lbs/MM Btu/hr=0.073
NOx emissions, lbs/MM Btu/yr=0.073*40*8,760=25,580

In addition to the significant and substantial cost savings and environmental impact by reducing noxious emissions by approximately 10,820 lbs/yr, eliminating the use of a separate fired heater will provide cost savings by eliminating the maintenance and operational costs associated with a fired heater. Moreover, construction costs and space are reduced by eliminating the requirement of a separate fired heater.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for processing a hazardous waste gas, which comprises:
preheating all of the waste gas,
burning impurities in all of the preheated waste gas to produce an exhaust gas; and
controlling a temperature of the exhaust gas before it is used to preheat the waste gas.

2. The method of claim 1, wherein the temperature of the exhaust gas is controlled in a quench chamber by maintaining it at about 1400° F.

3. The method of claim 1, wherein the temperature of the exhaust gas is controlled by using a quench air stream to cool the exhaust gas.

4. The method of claim 1, wherein the waste gas is preheated in a gas preheater to at least about 900° F.

5. The method of claim 1, wherein the waste gas is preheated by transferring heat from the exhaust gas to the waste gas.

6. The method of claim 1, further comprising preheating a utility oil stream by transferring heat from the exhaust gas to the utility oil stream.

7. The method of claim 6, wherein the utility oil stream is preheated to about 475° F. in a waste heat recovery module.

8. The method of claim 1, wherein the impurities in the waste gas are burned in a combustion chamber using a combustion air stream and a fuel gas stream.

9. The method of claim 8, wherein the temperature of the exhaust gas in the combustion chamber is at least about 1742° F.

10. The method of claim 1, wherein the impurities comprise benzene, tolene, ethyl-benzene and xylene.
